(19) United States
(12) Patent Application Publication
(10) Pub. No.: US 2008/0171100 A1
(43) Pub. Date: Jul. 17, 2008

(54) Constant-Force Belleville Spring and an Injection Molding Melt-Conveyance System Incorporating such a Spring as a Seal Spring

(75) Inventor: Abdeslam BOUTI, Swanton, VT (US)

Correspondence Address: HUSKY INJECTION MOLDING SYSTEMS, LTD;CO/AMC INTELLECTUAL PROPERTY GRP, 500 QUEEN ST. SOUTH, BOLTON, ON, L7E 5S5, omitted

(73) Assignee: HUSKY INJECTION MOLDING SYSTEMS LTD., Bolton (CA)

(21) Appl. No.: 11/624,115

(22) Filed: Jan. 17, 2007

(51) Int. Cl. B29C 45/17; F16B 39/24

(52) U.S. Cl. 425/569; 425/567; 425/573; 411/149

(57) ABSTRACT

An injection molding melt-conveyance system for conveying a molten molding material from an injection machine to an injection mold. The injection molding melt-conveyance system includes a first component having a first melt-channel and further includes a second component having a second melt-channel. A constant-force seal spring urges the first and second components toward one another so as to effect a seal that inhibits molten material flowing between the first and second melt channels from leaking through the seal. The constant force seal spring includes one or more Belleville springs each having an available deflection to thickness ratio chosen to provide that Belleville spring with a substantially constant spring force over a wide range of deflection.

### TECHNICAL FIELD OF THE INVENTION

The present invention generally relates to the field of injection molding. In particular, the present invention is directed to a constant-force Belleville spring and an injection molding melt-conveyance system incorporating such a spring as a seal spring.

### DESCRIPTION OF THE RELATED ART

In the art of injection molding of plastic parts/articles it is well known to utilize a hot runner to distribute molten plastic from an injection machine to the one or more mold cavities that receive the molten plastic and shape the one or more molded parts/articles. One type of hot-runner design, which is shown in U.S. Pat. No. 6,555,044 to Jenko, issued one Apr. 29, 2003, and titled “Hot Runner Valve Gate Piston Assembly” (incorporated by reference herein in its entirety), utilizes a manifold cavity plate and one or more plastic-distributing manifolds that are received in one or more corresponding manifold cavities formed in the plate. In this design, each plastic-distributing manifold is typically heated during use to maintain the molten plastic in the manifold at a proper temperature, e.g., using one or more electrical resistance heating elements that engage the manifold. A backing plate is usually used to enclose the manifold(s) within the respective cavity(ies). Each manifold has an outer surface that is typically spaced from the walls of its manifold cavity so as to provide an insulating air space between the manifold and each of the manifold cavity plate and backing plate.

This type of hot-runner design typically includes a plurality of nozzle assemblies, either thermal-gated or valve-gated, each having a nozzle housing secured to the manifold cavity plate and extending into a corresponding opening formed in the plate. Each nozzle housing includes a nozzle-housing melt-channel that carries the molten plastic from the manifold to a corresponding nozzle tip during molding. The manifold includes a corresponding manifold melt-channel that delivers the molten plastic to the nozzle-housing melt-channel. Of course, when the manifold and manifold cavity plate are at their operating temperatures, the manifold melt-channel and nozzle-housing melt-channel are highly aligned with one another so that their longitudinal central axes lie substantially along the same line. As mentioned, each manifold is heated, but the manifold plate is not. Consequently, due to the difference in temperature between these two components during operation, the matching ends of the nozzle-housing and manifold melt-channels move by differing amounts relative to a fixed reference during heat-up and cool-down. Therefore, when the manifold and manifold plate are cold, the matching ends of the nozzle-housing and manifold melt-channels are not in alignment.

A common way of handling this differential movement between the nozzle housing and manifold is to provide a metal-to-metal compression seal between the nozzle housing and manifold. This is often accomplished by providing a seal spring between the manifold cavity plate and the nozzle housing that urges the nozzle housing into sealing engagement with the manifold. This type of spring seal allows for both relative lateral translation between the nozzle housing and manifold and movement of the manifold and nozzle housing toward and away from one another due to heating and cooling.

While a spring seal between the nozzle housing and manifold can be very effective, much care must be taken to ensure that the various components that affect how much the seal spring is compressed, or deflected, are manufactured and milled to very close dimensional tolerances. This is so because the conventional seal spring used in these types of seals is a linear, variable force spring, i.e., a spring for which the spring force provided by the spring varies linearly with the spring's deflection from its relaxed state. Since the sealing force applied between the nozzle housing and manifold must be fairly precise, too much variation in the actual deflection of the spring relative to the design deflection will result in the sealing force being either too high or too low. Neither of these conditions is desirable. Consequently, tight dimensional tolerances affecting the deflection of the seal spring must be rigidly followed. Achieving such tight tolerances, however, typically leads to increased manufacturing costs.

### SUMMARY OF THE DISCLOSURE

In one embodiment, the present invention is directed to an urging device, comprising: a Belleville spring having: a thickness; an axis of rotational symmetry; an available deflection when the Bellville spring is in a relaxed state; and an overall height in the relaxed state; wherein the Belleville spring has a ratio of the available deflection to the thickness in a range of about 1.3 to about 1.7.

In another embodiment, the present invention is directed to an urging device, comprising: an annular cupped spring having: a thickness; an axis of rotational symmetry; an available deflection when the annular cupped spring is in a relaxed state; and an overall height in the relaxed state; wherein the thickness and the available deflection are selected to provide a spring force parallel to the axis of rotational symmetry that is substantially constant over a first range of deflection greater than 10% of the available deflection.

In a further embodiment, the present invention is directed to an injection molding melt-conveyance system for conveying a molten material from an injection machine to an injection mold, comprising: a first component having a first melt-channel; a second component having a second melt-channel for being in aligned fluid communication with the first melt-channel during use of the hot runner; and a constant-force seal spring urging the first component toward the second component toward so as to effect a seal between the first component and the second component so that the molten material is inhibited from leaking through the seal when the molten material moves between the first melt-channel and the second melt-channel.

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIG. 1 is a cross-sectional view of a portion of a hot runner made in accordance with the present invention that includes a constant-force Belleville spring;

FIG. 2 is a plan view of a constant-force Belleville spring in a relaxed state and made in accordance with the present invention and suitable for use in the hot runner of FIG. 1;

FIG. 3 is a cross-sectional view of the constant-force Belleville spring as taken along line 3-3 of FIG. 2;

FIG. 4 is a graph illustrating the relationship between the force resisted by various Belleville springs, including a constant-force Belleville spring of the present disclosure, versus their deflection for various ratios of available deflection to thickness of the springs;

FIG. 5 is a schematic view of a portion of another hot runner made in accordance with the present invention that includes a spring pack comprising a plurality of constant-force Belleville springs in a parallel configuration; and

FIG. 6 is a longitudinal cross-sectional view of a sprue bar assembly made in accordance with the present invention that includes a spring pack comprising a plurality of constant-force Belleville springs in a series configuration.

### DETAILED DESCRIPTION

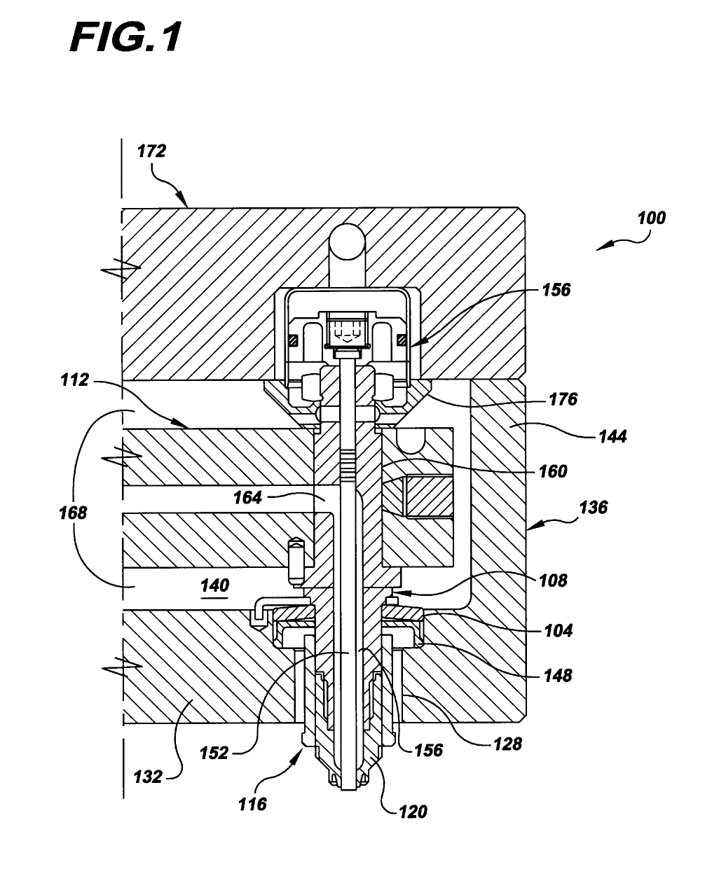

Referring now to the drawings, FIG. 1 illustrates an exemplary hot runner 100 that includes a constant-force Belleville spring 104 urging a nozzle housing 108 into sealing engagement with a manifold 112. (A Belleville spring is also known as a “cupped” spring, due to its frusto-conical, or cup, shape.) As described below in detail, constant-force Belleville spring 104 is specially configured to provide a substantially constant sealing force between nozzle housing 108 and manifold 112 over a relatively wide range of deflection of spring 104. As also described below, a ramification of this ability is that the dimensional tolerances of the components and features of hot runner 100 that can cause variation in the actual compressive deflection of constant-force Belleville spring 104 need not be as tight as would be needed if a conventional linear, variable force spring (not shown) were used.

Prior to describing the configuration of constant-force Belleville spring 104 that provides the desirable constant force over a range of deflection, however, exemplary hot runner 100 is described in more detail. It is noted that hot runner 100 is presented as but one example of many designs that may incorporate a constant-force Belleville spring made in accordance with the present disclosure, such as Belleville spring 104. Some of these alternative designs are mentioned below. However, those skilled in the art will readily appreciate that the alternatives mentioned are but a few of the many alternatives, and so, will understand that the concepts of the present invention have broad application.

Returning to exemplary hot runner 100, hot runner 100 includes one or more nozzle assemblies 116 (only one shown for convenience) that may include a nozzle 120, nozzle housing 108 and a nozzle heater 128, among other things. Nozzle assembly 116 may be engaged with a front plate 132, which may be part of a larger manifold cavity structure, e.g., plate 136, that defines a cavity 140 for receiving manifold 112 therein. Of course, alternative hot runners may have constructions that do not utilize a monolithic manifold cavity plate 136. For example, monolithic cavity plate 136 may be replaced by a separate front plate (not shown, but similar to front plate 132) with separate members (not shown) attached thereto to provide cavity walls similar to the cavity walls 144 of monolithic manifold cavity plate 136 shown. Nozzle assembly 116 may be partially held in place within front plate 132 via a generally annular insulator 148 made of a suitable thermally insulating material, such as titanium. Insulator 148 may be desirable to limit the amount of heat transferred from nozzle assembly 116 to front plate 132. Nozzle housing 108 may include one or more nozzle melt-channels 156 (one shown for convenience) that carries the molding material (not shown), e.g., molten plastic, to nozzle 120 during operation.

Since nozzle 120 shown is of the valve-gate type having a valve stem 152 actuated by a valve-gate actuator 156, manifold 112 may include a valve-stem bushing 160 that extends therethrough and includes a manifold melt-channel 164 that carries the molding material to nozzle housing 108. As described in the background section above, when manifold 112 and front plate 132 are cold, manifold melt-channel 164 and nozzle-housing melt-channel 156 are typically not in alignment with one another due to the differing thermal growths of manifold 112 and front plate 132 as these components are heated to their operating temperatures. However, a good seal is needed between manifold 112 (in this case, valve-stem bushing 160, but in other embodiments, such as a thermal-gate embodiment, could be another part of manifold 112) and nozzle housing 108 under operating conditions so as to inhibit the molding material from flowing between manifold 112 and nozzle housing 108 and into the insulating air space 168 between manifold 112 and manifold cavity plate 136. In this example, the sealing force needed to effectuate the seal between manifold 112 and nozzle housing 108 is essentially provided by constant-force Belleville spring 104, which is described in more detail below.

As those skilled in the art will readily appreciate, hot runner 100 may include other components as needed, such as a backplate 172 and a backup pad 176 that may be provided to transfer compressive forces from backplate 172 to manifold 112 when backplate 172 is properly fastened to manifold cavity plate 136. Generally, this compressive force is due to the forces provided by the one or more constant-force Belleville springs 104 provided for the one or more corresponding nozzle assemblies 116 that form part of the entire hot runner 100.

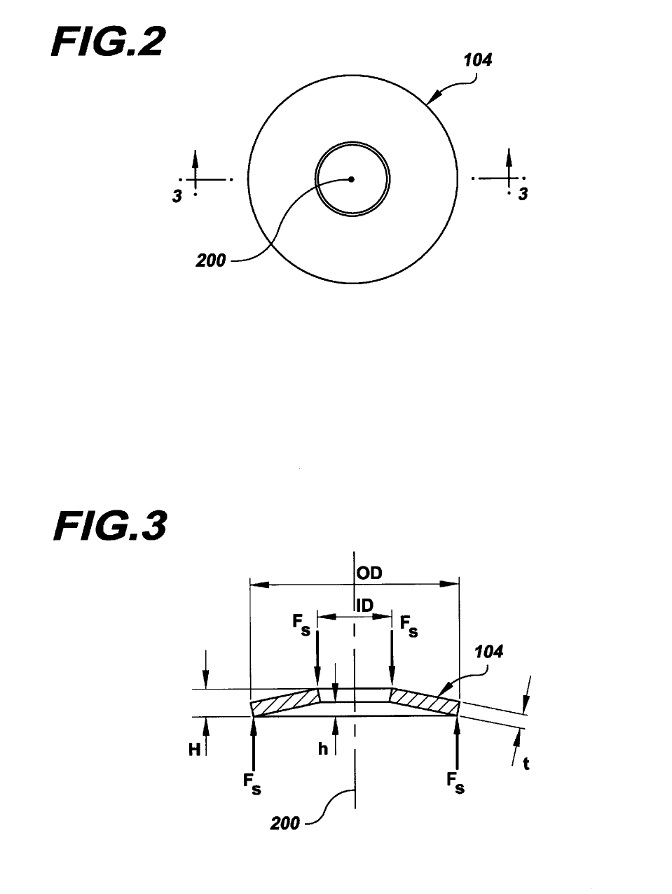

Turning now to the configuration of constant-force Belleville spring 104 that makes it a substantially constant-force spring, attention is directed to FIGS. 2 and 3. As shown in FIGS. 2 and 3, constant-force Belleville spring 104 is generally frusto-conically, or cup, shaped and may be considered to have an axis of rotational symmetry 200, an inside diameter ID, an outside diameter OD, a thickness t, an available deflection h and an overall uncompressed height H. When the ratio of h/t of constant-force Belleville spring 104 is made equal, or approximately equal, to the square-root of two, i.e., ˜1.41, the Belleville spring 104 will provide a substantially constant spring force Fs over a wide range of deflection. By “approximately equal” to the square-root of two it is meant that the hit ratio be in a range of about 1.3 to about 1.7.

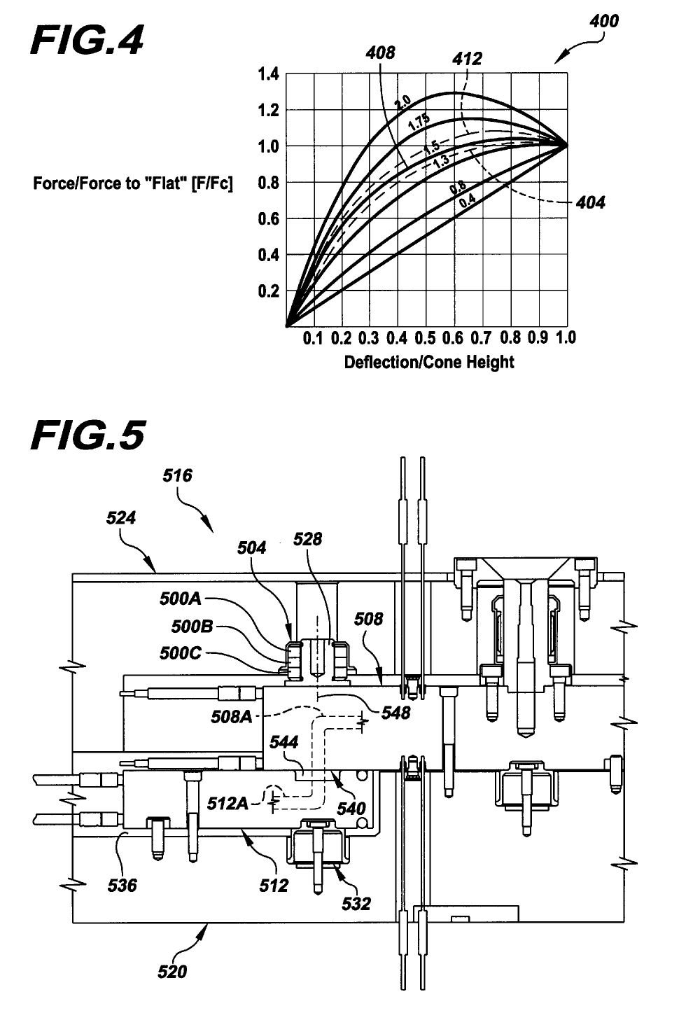

FIG. 4 contains a graph 400 illustrating the relationship of spring force Fs (FIG. 3) resisted/provided by constant-force Belleville spring 104 (FIGS. 1-3) as a function of the hit ratio. When hit is 1.4, as shown by curve 404 it is readily seen that the spring force is substantially constant from a deflection of about 70% of the available deflection h (i.e., a deflection/cone-height ratio of about 0.7 on graph 400) to a deflection of 100% of available deflection h (i.e., a deflection/cone-height ratio of 1.0 on graph 400 (spring fully flat)). This yields a substantially constant force over a range of about 30% of the available deflection h, or 0.3h. By “substantially constant” it is meant that the force/force-to-flat ratio does not vary from 1.0 by more than about 0.02, i.e., the force/force-to-flat ratio does not go above about 1.02 or below about 0.98 over the relevant deflection range (here, again, about 0.7h to 1.0h). As can be readily seen from graph 400, the curve 408 for an hit ratio of 1.5 illustrates that constant-force Belleville spring 104 will provide a substantially constant spring force over an even wider range of deflection, i.e., from just under 60% of the available deflection h to 100% of the available deflection h, a range of just over 0.4h. Similar results are shown for curve 412, which represents an hit ratio of 1.6.

Implications of having constant-force Belleville spring 104 (FIGS. 1-3) that provides a substantially constant force of a wide range of deflections include the ability to relax manufacturing tolerances of the various components of an assembly, e.g., a hot-runner such as hot-runner 100 of FIG. 1, that contribute to the in-situ deflection of spring 104. For example, say a conventional, i.e., non-constant-force, Belleville spring (not shown) is used in place of constant-force Belleville spring 104 in hot-runner 100 of FIG. 1 and assume that the sealing force needed between nozzle housing 108 and manifold 112 needs to be 30 kN±5 kN. If the non-constant force Belleville spring has a spring constant k of 61 kN/mm, then the design deflection must be 0.49 mm and the actual deflection must be in a range of 0.39 mm to 0.66 mm. This range, then, must account for manufacturing tolerances. It will be appreciated that to achieve such tight tolerances in an assembly such as hot runner 100 requires very precise and expensive milling, grinding and fitting.

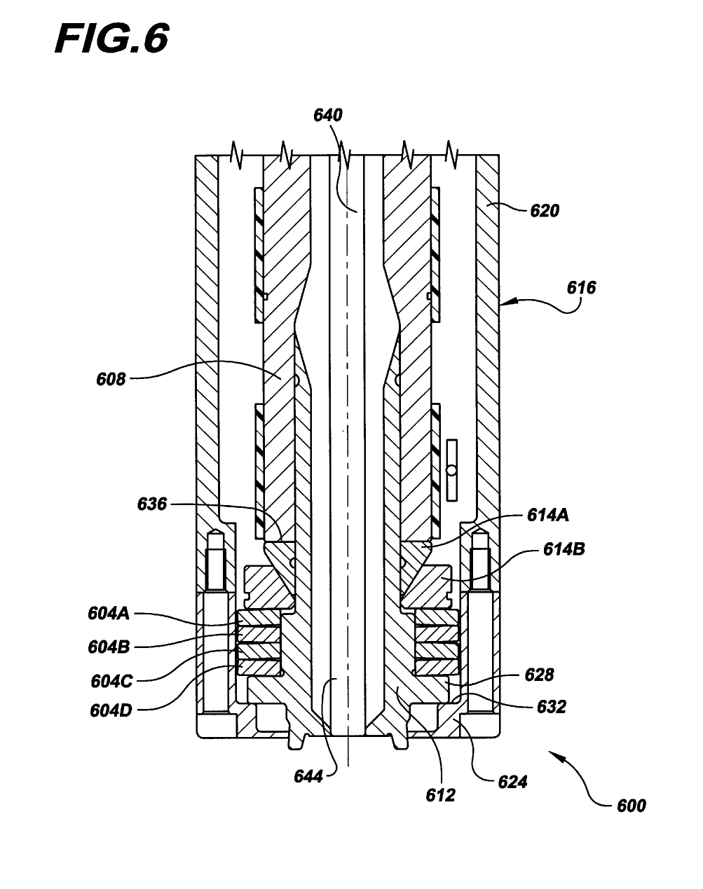

However, with constant-force Belleville spring 104 in this example having an hit ratio of 1.6 and an available deflection h of 3.7 mm, spring 104, by varying its physical dimensions, can be configured to provide the necessary sealing force of 31 kN over a range of deflection from about 0.6h to 1.0h, by using six springs, for example. Designing constant-force Belleville spring 104 to have an available deflection h of 2.8 mm, this means that the cumulative effect of manufacturing deviations, according to general design practice of Belleville spring can be as much as about ¾ of 0.4h, or 1 mm in this example, which is much larger than the range given above for the conventional, non-constant-force Belleville spring. Consequently, manufacturing of the components that affect the compression of constant-force Belleville spring 104 need not be as precise as for a conventional, non-constant-force Belleville spring. Less precision typically translates into cost savings, which are important to manufacturers and customers alike. In addition, it is noted that, if desired, constant-force Belleville spring 104 can be made by a manufacturing process less rigorous than the usual turning and grinding processes used to make conventional, i.e., non-constant-force, Belleville springs, such as stamping. This is so because the wide range of deflection over which constant-force Belleville spring 104 is designed to provide a substantially constant spring force allows for greater manufacturing tolerances. This, too, can lead to reduced manufacturing cost of the constant-force Belleville springs 104 themselves, as well as the assemblies that include them.

Whereas FIG. 1 illustrates an application in which only a single constant-force Belleville spring 104 is used to achieve a desired result (in FIG. 1, providing the appropriate sealing force for creating a seal between nozzle housing 108 and manifold 112), in other applications it may be desirable to use more than one constant-force Belleville spring to provide the design forces and/or deflections needed for such applications. For example, FIG. 5 (springs in a parallel arrangement) and FIG. 6 (springs in a series arrangement) illustrates such a use of multiple constant-force Belleville springs in the context of other injection molding melt conveyance system applications.

In the example of FIG. 5, three Belleville springs 500A-C are used in parallel to form a constant-force spring pack 504 that provides an appropriate sealing force between two manifolds 508, 512 within a multi-manifold-level hot runner 516. Hot runner 516 shown includes a manifold plate 520 and a backing plate 524. Manifold plate 520 and backing plate 524 may be fastened together in any suitable manner, such as using threaded fasteners (not shown). A spring holder 528 may be provided to hold constant-force spring pack 504 and the individual Belleville springs 500A-C in proper relation to backing plate 524 both during assembly of hot runner 516 and in the finished hot runner 516. On the opposite side of manifolds 508, 512, a locating insulator 532 or other structure may be provided for properly positioning manifold 512 within a cavity 536 formed in manifold plate 520. Locating insulator 532 may be secured to manifold plate 520, e.g., in any conventional manner.

With manifold and backing plates 520, 524 secured to one another, constant-force spring pack 504 works against this arrangement to compress the overlapping portion of manifolds 508, 512 between spring holder 528 and locating insulator 532 at a design compressive force Fc. This compressive force Fc is designed to effect a proper seal at an interface 540 between manifold 508 and manifold 512 so that the molding material, e.g., molten plastic, flowing from a melt-channel 508A of manifold 508 does not leak from the interface 540 as it passes into a melt-channel 512A of manifold 512. Interface 540 may be any suitable interface such as a direct face-to-face interface between two corresponding respective machined faces of the two manifold 508, 512 or, alternatively, an interface that utilizes a compression disk 544 or other type of intermediate structure or gasket, among others. Like the seal formed at the interface between nozzle housing 108 and valve-stem busing 160 of FIG. 1, the seal formed between manifolds 508, 512 allows for relative movement between manifolds 508, 512 during heating and cooling of hot runner 516. Those skilled in the art will readily recognize the type of interface needed to effect a suitable seal between manifolds 508, 512 and how to determine the compressive force Fc needed for that seal, such that further explanation is not necessary for those skilled in the art to practice the subject matter of the claims to its fullest scope. Of course, those skilled in the art will also be familiar with other components of hot runner 516, such that it is not necessary to describe these components in any detail.

In spring pack 504 shown in FIG. 5, each Belleville spring 500A-C of is a constant-force Belleville spring that is the same as or similar to constant-force Belleville spring 104 shown and described above in connection with FIGS. 1-4. That is, each Belleville spring 500A-C has an h/t ratio in a range of about 1.3 to about 1.7. Correspondingly, the various components of hot runner 516, e.g., backing plate 524, manifold plate 520, manifolds 508, 512, spring holder 528 and locating insulator 532, as well as Belleville springs 500A-C, are designed so that each Belleville spring 500A-C of constant-force spring pack 504 has an in-situ operating deflection that is within the corresponding range in which the force provided by that one of Belleville springs 500A-C is substantially constant, i.e., wherein the force/force-to-flat ratio (see FIG. 4) does not vary by about 0.04 (absolute) over the range. In addition, in this example Belleville springs 500A-C are in a “parallel” configuration with one another, i.e., are stacked along a common central stacking axis 548 so that their frusto-conical shapes nest with one another in their relaxed state. In this configuration, the spring forces provided by Belleville springs 500A-C are additive. Such parallel configuration is typically used to increase the loads resisted/provided by spring packs.

In other embodiments, Belleville springs 500A-C and/or other Belleville springs may be arranged in a “series” configuration, i.e., stacked in a non-nested manner along a common central stacking axis similar to common central stacking axis 548 of FIG. 5. (A series configuration is illustrated in FIG. 6.) When stacked in a series configuration, the deflections, rather than the spring forces, are additive so that the stack provides a greater range of deflection. Of course, spring packs (not shown) having Belleville springs stacked in both parallel and series configurations may be made. It is noted that in series and hybrid parallel-series configurations, fewer than all of the Belleville springs can be constant-force Belleville springs in the nature of constant-force Belleville spring 104 of FIGS. 1-4.

Whereas FIGS. 1 and 5 illustrate the use of one or more constant-force Belleville springs in a hot-runner context, those skilled in the art will readily appreciate that these springs may be used in other applications within injection molding melt-conveyance systems. For example, FIG. 6 illustrates a sprue bar assembly 600, which is generally known as a “split sprue bar” assembly, that includes four constant-force Belleville springs 604A-D arranged in a series configuration so as to provide a substantially constant spring force over a cumulative deflection that is roughly four times the deflection of a single one of the springs 604A-D. As those skilled in the art will readily understand, sprue bar assemblies such as sprue bar assembly 600 are often used in conjunction with stack-molds to convey the molten molding resin from an injection machine (not shown) to a hot runner (not shown). Since skilled artisans understand the uses of sprue bar assembly 600, no further discussion of such use is necessary.

In this example, each of constant-force Belleville springs 604A-D has been selected to provide substantially the same constant spring force over a relatively wide range of deflection. The physical parameters of each constant-force Belleville spring 604A-D that permit that spring 604A-D to provide such a constant force are discussed above in connection with FIGS. 2-4 relative to constant-force Belleville spring 104.

Other components of sprue bar assembly 600 include a sprue bar 608, a telescopic bushing 612, a pair of sealing wedges 614A-B and a housing 616 comprising a tubular sleeve 620 and end-piece 624 secured to the tubular sleeve 620. In this design, constant-force Belleville springs 604A-D allow telescopic bushing 612 to telescope into and out of sprue bar 608 by an amount limited by the complete flattening of springs 604A-D at one extreme and the interference between a flange 628 on the bushing 612 and a stopping surface 632 at the other extreme. Whether constant-force Belleville springs 604A-D are working against stopping surface 632 of end-piece 624 or against a mating portion of a mold (not shown) (thereby compressing springs 604A-D more than depicted in FIG. 6), springs 604A-D urge sealing wedge 614B into compressive engagement with each of sealing wedge 614A and the butt end 636 of sprue bar 608, thereby forming tight seal between sprue bar 608 and telescopic bushing 612 so that molten material (not shown) is inhibited from leaking from the sprue bar assembly 600 as it flows from a melt-channel 640 of sprue bar 608 into a melt-channel 644 of telescopic bushing 612.

As those skilled in the art will appreciate, when constant-force Belleville springs 604A-D are in the partially compressed states illustrated in FIG. 6, i.e., when flange 628 of telescopic bushing is contacting stopping surface 632 of end-piece 624, their compression may be at or near the lower end of the range in which the spring forces provided by the springs 604A-H is substantially constant. For example, when each constant-force Belleville spring 604A-D has an h/t ratio of 1.5 (see FIG. 4), the lower end of the substantially constant-force range may be just under 0.6h, i.e., just under 60% of the available deflection h. Consequently, the distance between sealing wedge 614B and flange 628 of telescopic bushing 612, i.e., the partially compressed length of the spring pack formed by constant-force Belleville springs 604A-D, is selected to be approximately equal to the sum of the thickness t of each spring 604A-D plus the sum of partial compressions at or near the lower end of the constant-force range (again, roughly 0.6h of the springs 604A-D), or about 4t+4(0.6h), which reduces to 4t+2.4h. Those skilled in the art will understand how to select the proper parameters for and numbers of the constant-force Belleville springs used for a particular application based on the appropriate design considerations for that application.

Exemplary embodiments have been disclosed above and illustrated in the accompanying drawings. It will be understood by those skilled in the art that various changes, omissions and additions may be made to that which is specifically disclosed herein without departing from the spirit and scope of the present invention.

What is claimed is:

1. An urging device, comprising:
a Belleville spring having:
a thickness;
an axis of rotational symmetry;
an available deflection when said Bellville spring is in a relaxed state; and
an overall height in said relaxed state;
wherein said Belleville spring has a ratio of said available deflection to said thickness in a range of about 1.3 to about 1.7.

2. The urging device of claim 1, wherein said ratio is about 1.4.

3. The urging device of claim 1, wherein said Belleville spring provides a spring force parallel to said axis of rotational symmetry that is substantially constant over a first range of deflection greater than 10% of said available deflection.

4. The urging device of claim 3, wherein said first range ends substantially at said available deflection.

5. The urging device of claim 3, wherein said spring force is substantially constant over a second range of deflection greater than 20% of said available deflection.

6. The urging device of claim 5, wherein said second range ends substantially at said available deflection.

7. The urging device of claim 5, wherein said spring force is substantially constant over a third range of deflection greater than 30% of said available deflection.

8. The urging device of claim 7, wherein said third range ends substantially at said available deflection.

9. The urging device of claim 1, comprising a plurality of Belleville springs stacked with one another along a common central stacking axis, said ratio of each of two or more of said plurality of Belleville springs being in a range of about 1.3 to about 1.7.

10. The urging device of claim 9, wherein said ratio of each one of all of said plurality of Belleville springs is in a range of about 1.3 to about 1.7.

11. The urging device of claim 9, wherein said plurality of Belleville springs are stacked in a parallel or in a series configuration or a combination of both.

12. An urging device, comprising:
an annular cupped spring having:
a thickness;
an axis of rotational symmetry;
an available deflection when said annular cupped spring is in a relaxed state; and
an overall height in said relaxed state;
wherein said thickness and said available deflection are selected to provide a spring force parallel to said axis of rotational symmetry that is substantially constant over a first range of deflection greater than 10% of said available deflection.

13. The urging device of claim 12, wherein said first range ends substantially at said available deflection.

14. The urging device of claim 12, wherein said spring force does not vary more than about 4% of said spring force over said first range.

15. The urging device of claim 12, wherein said spring force is substantially constant over a second range of deflection greater than 20% of said available deflection.

16. The urging device of claim 15, wherein said second range ends substantially at said available deflection.

17. The urging device of claim 15, wherein said spring force does not vary more than about 4% of said spring force over said second range.

18. The urging device of claim 15, wherein said spring force is substantially constant over a third range of deflection greater than 30% of said available deflection.

19. The urging device of claim 18, wherein said third range ends substantially at said available deflection.

20. The urging device of claim 18, wherein said spring force does not vary more than about 4% of said spring force over said third range.

21. An injection molding melt-conveyance system for conveying a molten material from an injection machine to an injection mold, comprising:
a first component having a first melt-channel;
a second component having a second melt-channel for being in aligned fluid communication with said first melt-channel during use of the hot runner; and
a constant-force seal spring urging said first component toward said second component toward so as to effect a seal between said first component and said second component so that the molten material is inhibited from leaking through said seal when the molten material moves between the first melt-channel and the second melt-channel.

22. The injection molding melt-conveyance system of claim 21, wherein said first component comprises a nozzle housing and said second component comprises a manifold.

23. The injection molding melt-conveyance system of claim 21, wherein said first component comprises a first manifold and said second component comprises a second manifold.

24. The injection molding melt-conveyance system of claim 21, wherein said first component comprises a sprue bar and said second component comprises a telescopic bushing.

25. The injection molding melt-conveyance system of claim 21, wherein said constant-force seal spring comprises:
an annular cupped spring having:
a thickness;
an axis of rotational symmetry;
an available deflection when said annular cupped spring is in a relaxed state; and
an overall height in said relaxed state;
wherein said thickness and said available deflection are selected to provide a spring force parallel to said axis of rotational symmetry that is substantially constant over a first range of deflection greater than 10% of said available deflection.

26. The injection molding melt-conveyance system of claim 25, wherein said first range ends substantially at said available deflection.

27. The injection molding melt-conveyance system of claim 25, wherein said spring force does not vary more than about 4% of said spring force over said first range.

28. The injection molding melt-conveyance system of claim 25, wherein said spring force is substantially constant over a second range of deflection greater than 20% of said available deflection.

29. The injection molding melt-conveyance system of claim 28, wherein said second range ends substantially at said available deflection.

30. The injection molding melt-conveyance system of claim 28, wherein said spring force does not vary more than about 4% of said spring force over said second range.

31. The injection molding melt-conveyance system of claim 28, wherein said spring force is substantially constant over a third range of deflection greater than 30% of said available deflection.

32. The injection molding melt-conveyance system of claim 31, wherein said third range ends substantially at said available deflection.

33. The injection molding melt-conveyance system of claim 31, wherein said spring force does not vary more than about 4% of said spring force over said third range.

34. The injection molding melt-conveyance system of claim 25, wherein said annular cupped spring has a ratio of said available deflection to said thickness in a range of about 1.3 to about 1.7.

35. The injection molding melt-conveyance system of claim 34, wherein said ratio is about 1.4.

36. The injection molding melt-conveyance system of claim 21, wherein said constant-force spring is a Belleville spring.

37. The injection molding melt-conveyance system of claim 21, wherein said constant-force spring comprises a plurality of Belleville springs stacked along a common stacking axis.

38. The injection molding melt-conveyance system of claim 37, wherein said plurality of Belleville springs are stacked in a parallel configuration.

39. The injection molding melt-conveyance system of claim 37, wherein said plurality of Belleville springs are stacked in a series configuration.
